(19) United States
(12) Patent Application Publication
(10) Pub. No.: US 2016/0107740 A1
(43) Pub. Date: Apr. 21, 2016

(54) INSPECTION DEVICE AND METHOD FOR USE

(71) Applicant: P. PONK AVIATION, Camano Island, WA (US)

(72) Inventor: STEVEN KNOPP, Camano Island, WA (US)

(21) Appl. No.: 14/519,925

(22) Filed: Oct. 21, 2014

(51) Int. Cl. B64C 1/00; E05D 15/00; E06B 3/34; E05D 7/00

(52) U.S. Cl. CPC B64C 1/00; E05D 7/00; E05D 15/00; E06B 3/34

(57) ABSTRACT

A flush inspection portal that will allow quick access into inspection areas.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

The Federal Aviation Administration (“FAA”) requires an aircraft owner to periodically inspect his aircraft to determine if it is in a safe condition for flight. An inspection must be done at least annually. The required inspection period may increase depending on the type of aircraft and the conditions under which it is flown. Inspections can include visual inspections and manual checks to determine the condition of the aircraft or a component. In some aircraft, wings, fuselage and empennage are inspected and maintained through flush mounted inspection ports (“ports”). By way of example, FIGS. 1 and 2 show inspection ports on the wings and fuselage of aircraft made by Cessna. Most likely, the ports are accessed through cover plates which are held in place with screws. Removing cover plates is time extensive, and there is a risk the inspector will lose screws and/or the cover plate in the process. In most planes, this process takes approximately 24 to 32 man hours, at $75 to $125 per hour, with much of that time spent removing and reassembling inspection plates. Additionally, there is an added difficulty when working with sea planes. Sea planes often have to be removed from the water before inspection can be made within the ports for the reasons described above. There is a need for a quick access inspection portal.

### BRIEF DESCRIPTION OF INVENTION

It is an object of this invention to provide a flush inspection portal that will allow quick access into inspection areas. Another object of this invention is to reduce the number of man hours required for periodic inspection of aircraft. Another object of this invention is to provide a flush inspection portal that is durable against extreme temperature changes and vibrations. Another object of this invention is to provide access to inspection ports that is easily replaceable/repairable. Another object of this invention is to provide inspection portals that may replace cover plates as an after factory add on or as an in factory process.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a portion of a Cessna illustrated parts catalog showing inspection ports;

FIG. 2 is a portion of a Cessna illustrated parts catalog showing inspection ports;

FIG. 3a is a perspective view of the portal operably attached to an inspection plate;

FIG. 3b is a side view of the portal operably attached to an inspection plate;

FIG. 4a is a top, perspective view of the base plate;

FIG. 4b is a top view of the base plate;

FIG. 4c is a section view of the base plate taken from 4C-4C;

FIG. 5a is a top, perspective view of the cover;

FIG. 5b is a bottom view of the cover;

FIG. 5c is a section view of a flexible-hook taken from section 5C-5C;

FIG. 5d is a detailed, section view of the butt-type hinge taken from section 5E-5E;

FIG. 5e is a side, section view of the cover taken from section 5E-5E;

FIG. 6a is a perspective view of the dowel;

FIG. 6b is a sectional view of the dowel taken from 6B-6B;

FIG. 6c is an end view of the dowel;

FIG. 7 is a bottom view showing an inspection port covered by an inspection plate.

### DETAILED DESCRIPTION OF THE INVENTION

The present invention, a flush mount, quick access inspection portal (“portal) (10), is described more fully hereinafter with reference to the accompanying drawings, in which preferred embodiments of the invention are shown. This invention may, however, may be embodied in many different forms and should not be construed as limited to the embodiments set for herein; rather, these embodiments are provided so that this disclosure will be thorough and complete and will fully convey the scope of the invention to those skilled in the art.

The portal (10) is described here as substantially circular or circular for exemplary purposes. A person having ordinary skill in the art will note that the shape and size of the portal (10) may vary depending upon the inspection area and aircraft. The portal (10) may be constructed from metal, plastic, ceramic, or a combination thereof, or any other material that may have similar properties.

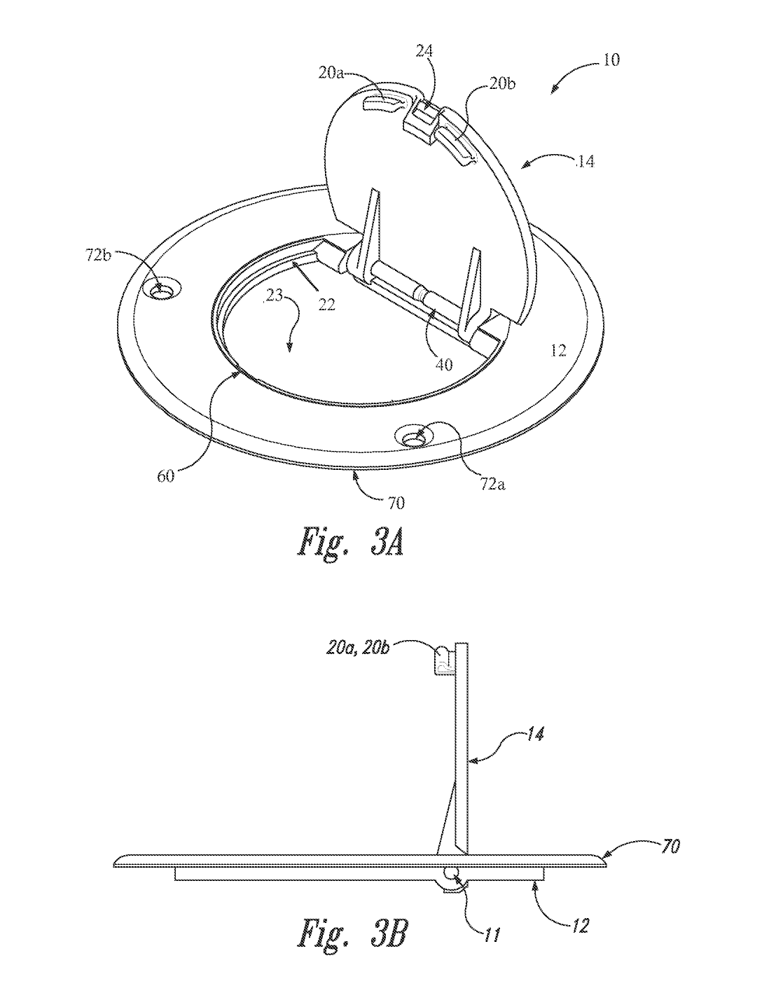

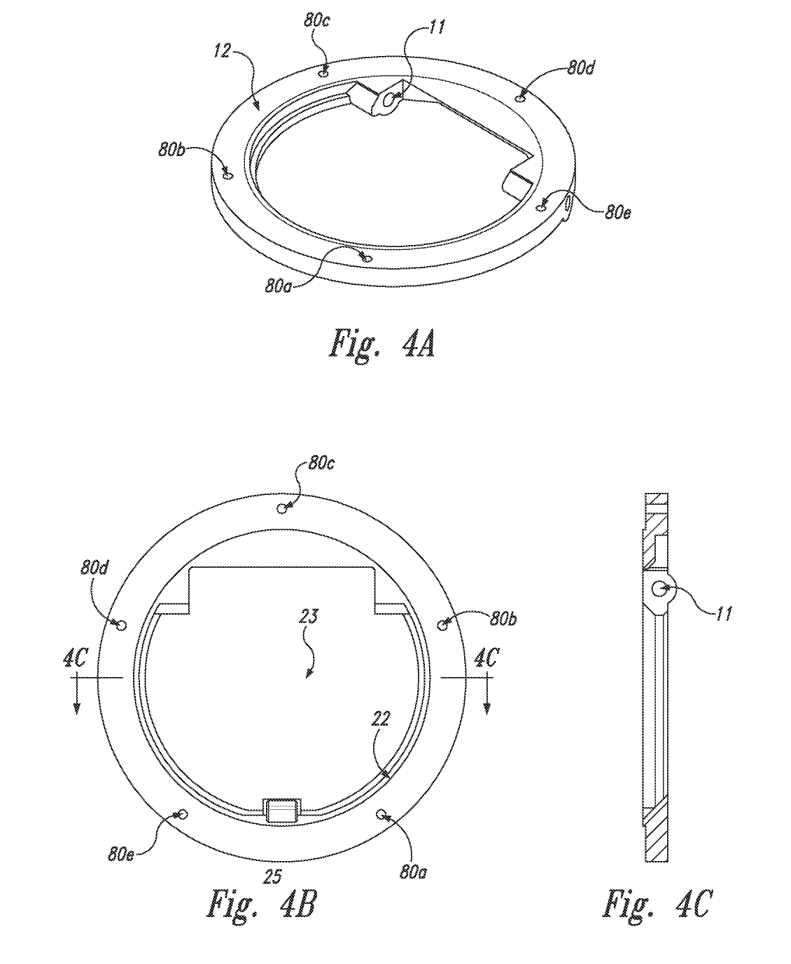

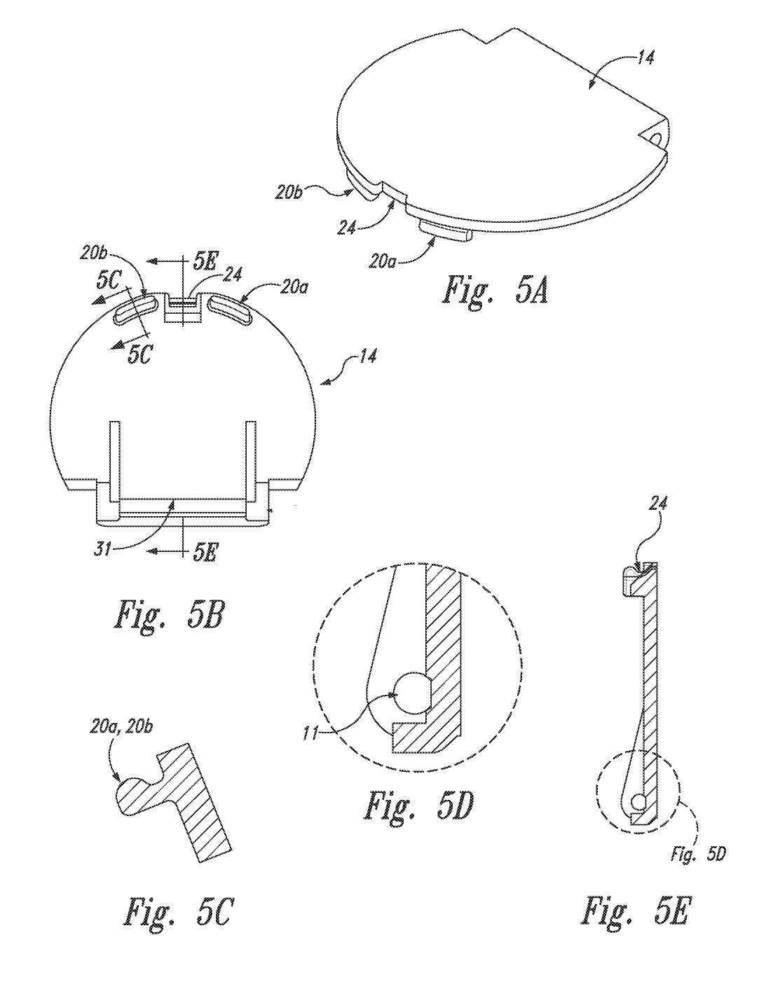

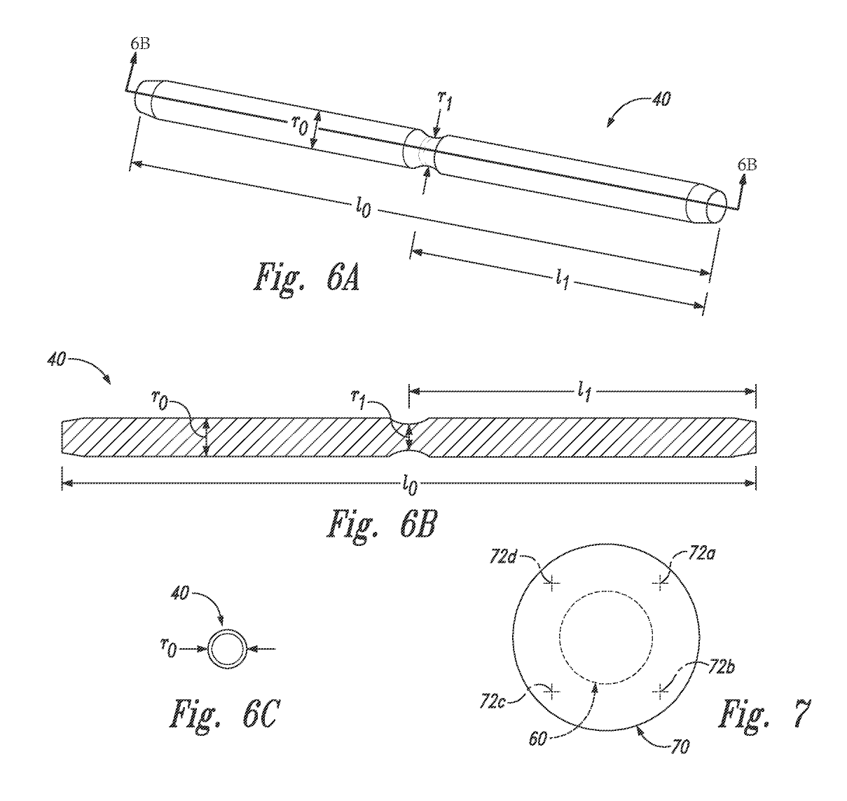

Referring to FIGS. 3A through 7, in an embodiment, the portal (10) has a substantially L-shaped cross section. The portal (10) is comprised of a base plate (12), a cover (14), and a hinge (11). The base plate (12) is a ring which defines a hole (23). The hole (23) is of sufficient size to allow inspection from an inspection port. The inner portion of the base plate (12) defines at least one flange (22).

The cover (14) is operably coupled to the base plate (12). Preferably, the cover (14) is attached to the base plate (12) using a butt-type hinge (11) utilizing a dowel (40).

In a closed position, the cover (14) is secured to the base plate (12) so that the two are flush. Preferably, the cover (14) and base plate (12) define a pressure-type lock. More specifically, at the diameter opposite the butt-type hinge (11), at least one flexible hook (20a, 20b) extends perpendicularly from the cover (14). Preferably, the cover (14) also defines at least one cover insertion ramp (24) near the flexible-hook (20a, 20b). Preferably, the base plate (12) comprises at least one base plate insertion ramp (25) that engages the cover insertion ramp (24).

When pressure is applied to the cover (14) in the direction of the base plate (12), the flexible hook (20a, 20b) deflects slightly in the direction of the butt-type hinge (11). When pressure is released, the flexible hook (20a, 20b) deflects back to its original position allowing it to hook onto the flange (22). The cover (14) is placed in an open position by applying pressure to the cover (14) in the direction of the butt-type hinge (11) by using a screwdriver or other similar instrument inserted into the base plate insertion ramp (25) and the cover insertion ramp (24). This pressure allows the flexible hooks (20a, 20b) to deflect away from the flange (22) releasing its seal.

The dowel (40) has a radius (r₀) and a length (l₀). Preferably, a portion of the dowel (40) has a second radius (r₁) which is smaller than the (r₀). Preferably, the second radius (r₁) is located at the center of the length (l₁) of the dowel (40). That is, the second radius (r₁) is bordered on either side by radius (r₀). Preferably, the cover (14) further comprises a rib (31) along the butt-type hinge (11) that engages with the second radius (r₁) when the dowel (40) is moved through the butt-type hinge (11).

This configuration provides two advantages. First, the butt-type hinge (11) is secured in place so that it does not loosen because of vibrations or jarring. Second, this configuration allows the cover (14) to be easily changed out, if it is broken. If the cover (14) has broken, a second dowel (40a) is used to push out the first dowel (40b), allowing a first cover (14a) to be removed, and a replacement cover (14a) to be reinstalled.

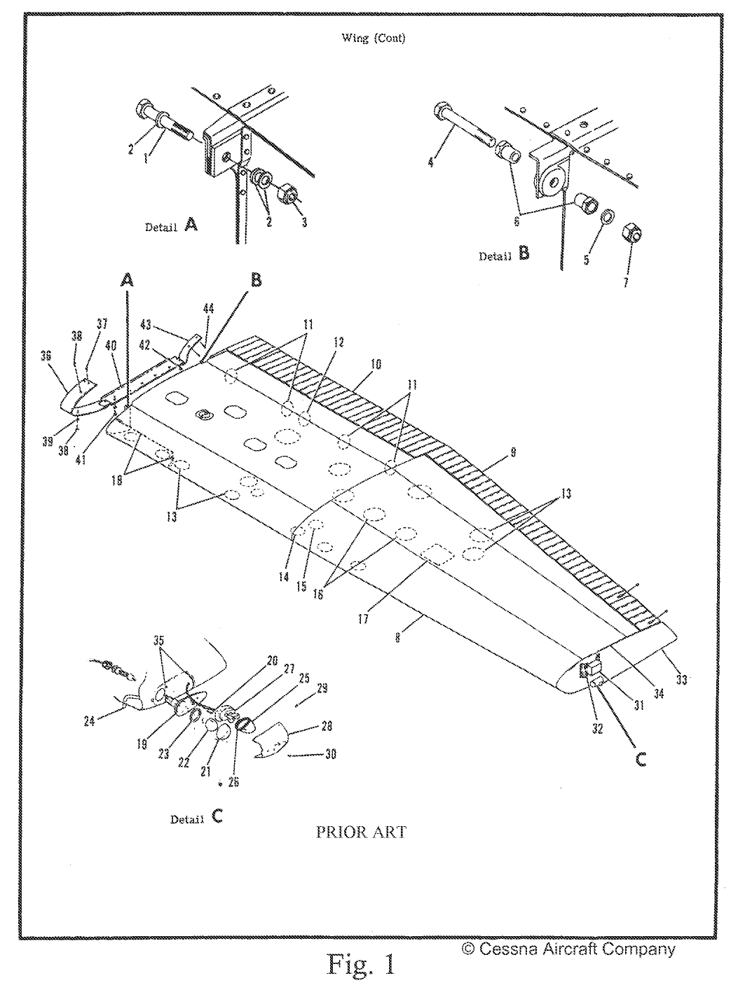

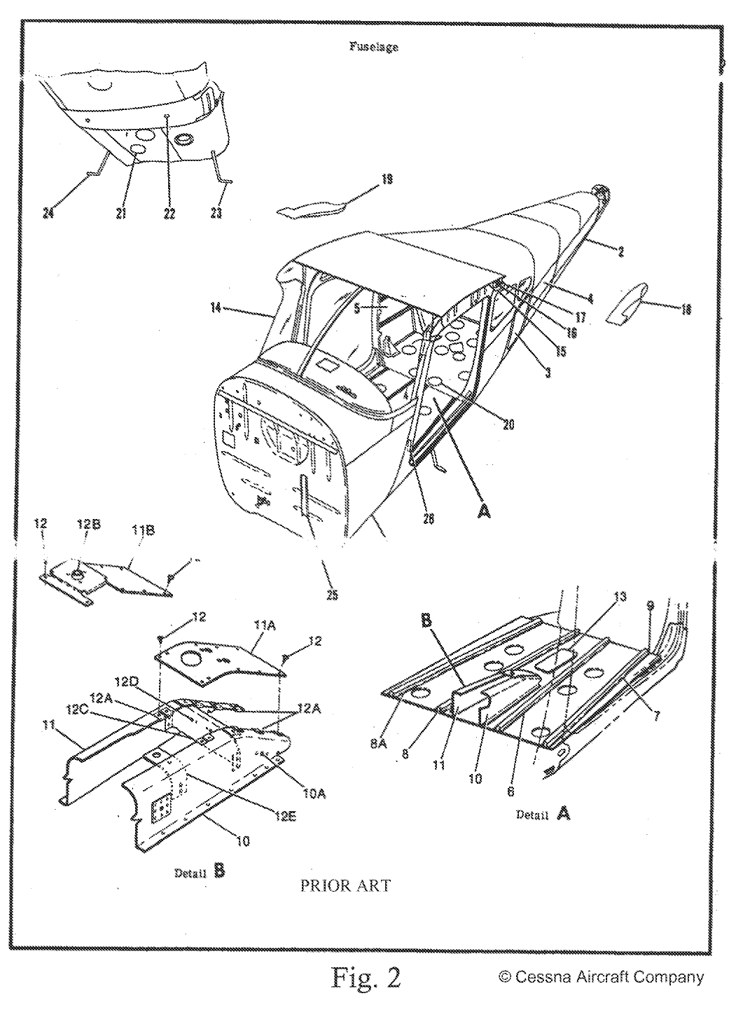

As discussed above, referring to FIG. 7, in most aircraft inspection ports (60) are covered by inspection plates (70). The inspection plates (70) are usually held in place by screws (72a, 72b, 72c, 72d), for example. To couple the portal (10) to an inspection port (60), a hole is cut out of the inspection plate (70). The hole is sufficient in size so as to allow access to the inspection port (60). The portal (10) is attached to the inspection plate (70) using any known fastener so that the cut out hole of the inspection plate (70) aligns with the base plate (12) hole (23), as shown in FIG. 1. Preferably, the base plate (12) defines a plurality of holes (80a, 80b, 80c, 80d), for example, that can be used to fasten the inspection plate (70) to the base plate (12) using screws, for example. The inspection plate (70) is then re-installed on to the aircraft. The portal (10) may also be attached at the aircraft during the manufacturing process.

1. A flush mount, quick inspection portal for aircraft comprising:
a base plate, a cover, and a hinge; where the cover is operably connected to the base plate with the hinge; where the hinge is a butt hinge; where the butt hinge has at least two matching leaves joined together with a removable pin; where the removable pin has at least a first diameter and a second diameter; where the first diameter is smaller than the second diameter; where the cover is further comprised of a pressure lock.

2. (canceled)

3. (canceled)

4. The inspection portal of claim 2 where the base plate is a ring.

5. A method to use the inspection portal of claim 1 comprises attaching the base plate to an inspection plate.

6. A method to use the inspection portal of claim 1 comprises attaching the inspection portal to an aircraft.

7. A method to use the inspection portal of claim 1 comprises placing the cover into the open position.

8. A method to use a flush mount, quick inspection portal for aircraft comprising:
a base plate, a cover, and a hinge; where the cover is operably connected to the base plate with the hinge; where the hinge is a butt hinge; where the butt hinge has at least two matching leaves joined together with a removable pin; where the removable pin has at least a first diameter and a second diameter; where the first diameter is smaller than the second diameter; where the cover is further comprised of a pressure lock; where the flush mount, quick inspection portal is attached to an aircraft.
